(19) United States
(12) Patent Application Publication
(10) Pub. No.: US 2007/0064174 A1
(43) Pub. Date: Mar. 22, 2007

(54) Illuminating device, and light source unit incorporating same

(75) Inventors: Atsushi Kitamura, Kitasaku-gun (JP); Toru Kunimochi, Kitasaku-gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 11/503,928

(22) Filed: Aug. 15, 2006

(30) Foreign Application Priority Data
Sep. 22, 2005 (JP) 2005-275584

(51) Int. Cl. G02F 1/1335

(52) U.S. Cl. 349/69

(57) ABSTRACT

There is provided an illuminating device which includes: a surface light source including a plurality of light emitting diodes disposed two-dimensionally; a light condensing means comprising a plurality of Fresnel lenses which are disposed corresponding to respective light emitting diodes, and each of which converts a light from each light emitting diode into a substantially collimated light; and a light diffusing means disposed at the stage consequent to the light condensing means, and including a plurality of Fresnel lenses which have a smaller diameter and are arranged in a higher density than the Fresnel lenses of the light condensing means. The illuminating device is adapted to emit a highly bright light with excellence in brightness uniformity, and a light source unit incorporating the illuminating device disposed behind a liquid crystal panel is suitably used in an HUD.

### BACKGROUND OF THE INVENTION

1. Field of the Invention

The present invention relates to an illuminating device, and a light source unit incorporating an illuminating device, and more particularly to a light source unit suitable for use in a head-up display.

2. Description of the Related Art

In recent years, a head-up display (hereinafter referred to as HUD as appropriate) has been increasingly used in aircrafts and automobiles, which presents image information superposed on a viewer's outside scene ahead of the aircrafts or automobiles. FIG. 5 is a schematic view of a typical on-vehicle HUD system, where an HUD 100 includes a light source unit 110 and a projection optical system 104 which are disposed inside an instrument panel 101. The light source unit 110 usually includes a light-transmissive liquid crystal panel 103 and an illuminating device 102 disposed behind the liquid crystal panel 103. Image information O produced by the light source unit 110 is projected onto a windshield 105 by means of the projection optical system 104 constituted by, for example (in the figure), a concave mirror, and a driver D views a virtual image I thereby reading the image information O without substantially diverting its attention from the normal line of sight.

FIG. 6 is a cross sectional view of a typical structure for the light source unit 110 used in the HUD 100 described above (refer to, for example, Japanese Utility Model Application Laid-Open No. H6-68957, and Japanese Patent Application Laid-Open No. H8-238955). The illuminating device 102 includes discharge lamps 114, for example ultrahigh pressure mercury lamps, as its light source and illuminates the liquid crystal panel 103 from behind. A reflector plate 115 is disposed behind the discharge lamps 114, and a heat blocking glass 116 to cut off heat rays from the discharge lamps 114 and a diffuser plate 117 to diffuse and spread lights emitted from the discharge lamps 114 are disposed between the discharge lamps 114 and the liquid crystal panel 103.

In an illuminating device, in which discharge lamps are used as its light source as described above, the following drawbacks are involved. A driving circuit is required which generates a high voltage to light a discharge lamp thus increasing the structural dimension. Also, a discharge lamp generates a large amount of heat making it necessary, in many cases, to take measures to deal with the heat, for example, installation of a cooling fan, and at the same time power consumption reduction is a difficult issue to address. Due to the aforementioned drawbacks, use of an HUD has been seen only in large-size automobiles or limited types of vehicles which afford enough space for its installation. Under the circumstances, approaches have been tried to use an illuminating device employing a light emitting diode (hereinafter referred to as LED as appropriate) which enables simplification of a driving circuit and also which consumes less power and generates less heat than a discharge lamp. However, use of an LED generally results in a dark display image thus providing a poor visibility.

### SUMMARY OF THE INVENTION

The present invention has been made in light of the above problem, and it is an object of the present invention to provide a downsized illuminating device which uses a plurality of LEDs and which achieves a high and uniform brightness, and to provide also a light source unit which incorporates such an illuminating device so as to be suitably used in an HUD.

In order to achieve the object described above, according to one aspect of the present invention, there is provided an illuminating device which includes: a surface light source including a plurality of light emitting diodes disposed two-dimensionally; and a light condensing means including a plurality of Fresnel lenses which are disposed corresponding to respective light emitting diodes, and each of which converts a light from each light emitting diode into a substantially collimated light. The illuminating device may further include a light diffusing means disposed at the stage consequent to the light condensing means, wherein the light diffusing means includes a plurality of Fresnel lenses which have a smaller diameter and are arranged in a higher density than the Fresnel lenses of the light condensing means.

In the one aspect of the present invention, the Fresnel lenses of the light condensing means may have an F-value of 1 or smaller, and the Fresnel lenses of the light diffusing means may define a concave lens curve in profile.

Consequently, lights emitted from the plurality of LEDs can be efficiently condensed by the light condensing means thereby enhancing the front brightness for the illuminating device. Since a driving circuit to generate a high voltage is not required, and since heat dissipation measures can be simplified due to reduced heat value from the light source, the illuminating device can be reduced in dimension and cost. Since the light condensing means is constituted by Fresnel lenses, its thickness can be reduced thus contributing to downsizing, and its F-value can be set to 1 or smaller thus improving the condensing efficiency and therefore achieving an increased brightness compared with bulk lenses. Further, since the light diffusing means constituted by the Fresnel lenses arranged as described above incurs reduced light loss, the brightness uniformity of light emitted from the illuminating device can be enhanced with its brightness maintained. And, since the Fresnel lenses to constitute the light diffusing means can be flexibly designed to have individually different characteristics, the light diffusing means proves advantageous in that the brightness uniformity achieved by diffusing light and the front brightness achieved by condensing light can be optimally balanced.

Also, in order to achieve the object, according to another aspect of the present invention, there is provided a light source unit incorporating an illuminating device which is structured as described in the one aspect of the present invent, and which is disposed behind a liquid crystal penal which includes a pair of substrates functioning as electrodes, and liquid crystals disposed between the pair of substrates.

The light source unit described above is adapted to emit light with a high and uniform brightness at a low power consumption and therefore is suitably used in an HUD.

### BRIEF DESCRIPTION OF THE DRAWINGS

FIG. 1A is a top plan view of a light source unit of the present invention incorporating an illuminating device according to an embodiment of the invention, shown with an upper portion of the light source unit removed, and FIG. 1B is a side cross sectional view of the light source unit of FIG. 1A;

FIG. 2A is a schematic front elevation view of a light condensing means of the illuminating device shown in FIG. 1A/1B, and FIG. 2B is a cross sectional view of the light condensing means taken along line A-A in FIG. 2A;

FIG. 3A is a schematic front elevation view of a light diffusing means of the illuminating device shown in FIG. 1A/1B, and FIG. 3B is a cross sectional view of the light diffusing means taken along A-A in FIG. 3A;

FIG. 4 is an explanatory top plan view of a relevant portion of the illuminating device according to the embodiment of the present invention;

FIG. 5 is a schematic view of a structure of a typical HUD; and

FIG. 6 is a schematic cross sectional view of a typical light source unit used in the HUD of FIG. 5.

### DETAILED DESCRIPTION OF THE INVENTION

A preferred embodiment of the present invention will hereinafter be described with reference to the accompanying drawings.

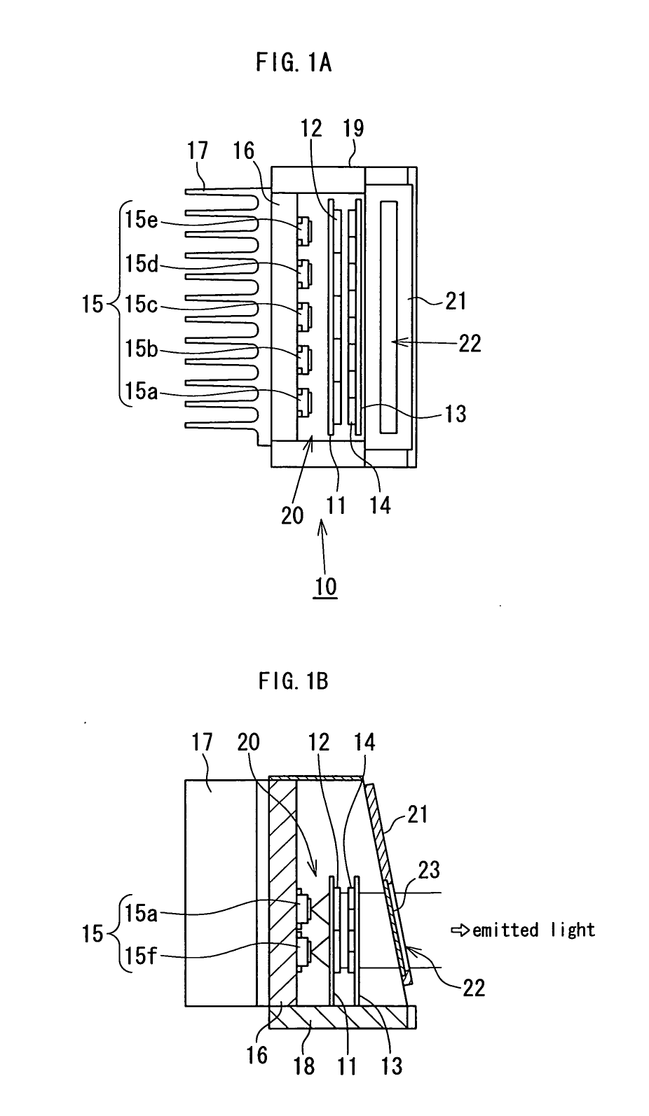

Referring to FIGS. 1A and 1B, a light source unit 10 of the present invention includes a housing 19, a liquid crystal panel 23 disposed in front of the housing 19, and an illuminating device 20 disposed inside the housing 19 so as to be located behind the liquid crystal panel 23. The liquid crystal panel 23 is a well known light modulating means constituted such that liquid crystals are sandwiched between a pair of substrates working as electrodes. In the light source unit 10 described above, image information produced by the liquid crystal panel 23 is illuminated from behind by the illuminating device 20 so as to be projected onto a projection optical system (not shown) through an aperture 22 formed at a light shielding plate 21.

According to the present embodiment, the illuminating device 20 includes, as shown in FIGS. 1A and 1B, a surface light source 15, a light condensing means 12 disposed at a stage subsequent to the surface light source 15, and a light diffusing means 14 disposed at a stage subsequent to the light condensing means 12. In this connection, the object of the present invention can be basically accomplished by the illuminating device 20 excluding the light diffusing means 14 as will be described later, which suggests that the light diffusing means 14 is not an essential constituent, though this fundamental exemplar is not specifically illustrated.

The surface light source 15 is composed of a plurality (ten in the present embodiment) of LEDs 15a to 15j (15g to 15j are not shown in FIG. 1A or 1B) which are mounted on a radiator plate 16 and two-dimensionally arrayed to form two lines. The radiator plate 16 includes a base made of, for example, aluminum, and a circuit pattern formed at the base with an insulation layer (not shown) interposed therebetween, and a heat sink 17 including a plurality of radiation fins is attached to the base of the radiator plate 16.

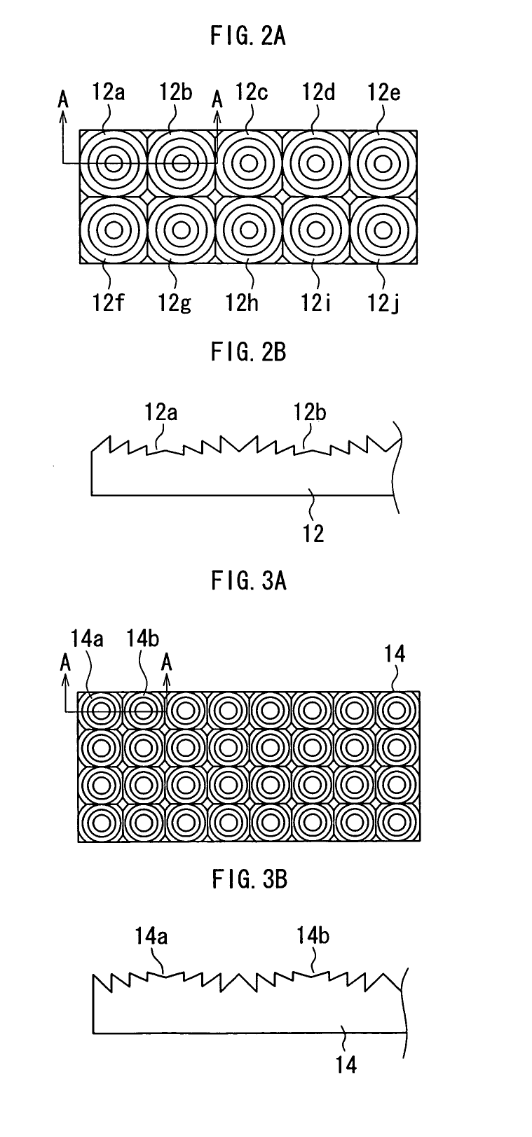

Referring to FIGS. 2A and 2B, the light condensing means 12 includes a plurality (ten in FIG. 2A) of Fresnel lens cells 12a to 12j which are formed on one surface of a transparent substrate made of, for example, acrylic resin, and which are arranged in two lines so as to be in contact with one another, and, as shown in FIG. 1B, is disposed at the stage subsequent to the surface light source 15 such that the other surface of the transparent substrate is fixedly attached to a transparent plate 11 which is made of acrylic resin, or like material, and which stands fixedly on an aluminum plate 18. The Fresnel lens cells 12a to 12j are each shaped to define a convex lens curve in profile as shown in FIG. 2B. Specifically, each of the Fresnel lens cells 12a to 12j is composed of a plurality of prisms whose respective refracting surfaces aggregate so as to constitute a curved surface of one convex lens. The Fresnel lens cells 12a to 12j preferably have an F-value (focal length/effective aperture) of about 0.7 and are located to duly receive respective lights emitted from the LEDs 15a to 15j.

Referring now to FIGS. 3A and 3B, the light diffusing means 14 includes a plurality (thirty two in FIG. 3A) of Fresnel lens cells 14a, 14b and so on, which are formed on one surface of a transparent substrate made of, for example, acrylic resin, and which are arranged in four lines so as to be in contact with one another, and, as shown in FIG. 1B, it is disposed at the stage subsequent to the light condensing means 12 such that the other surface of the transparent substrate is fixed attached to a transparent plate 13 which is made of acrylic resin, and like material, and which stands fixedly on the aluminum plate 18. The transparent substrate of the light diffusing means 14 has an surface area substantially identical with the surface area of the transparent substrate of the light condensing means 12, and the Fresnel lens cells 14a, 14b and so on of the light diffusing means 14 have a smaller diameter than the Fresnel lens cells 12a to 12j of the light condensing means 12 are therefore arranged in a higher density than the Fresnel lens cells 12a to 12j as known from FIGS. 2A and 3A. The Fresnel lens cells 14a, 14b and so on are each shaped to define a concave lens curve in profile as shown in FIG. 3B. Specifically, each of the Fresnel lens cells 14a, 14b and so on is composed of a plurality of prisms whose respective refracting surfaces aggregate so as to constitute a curved surface of one concave lens.

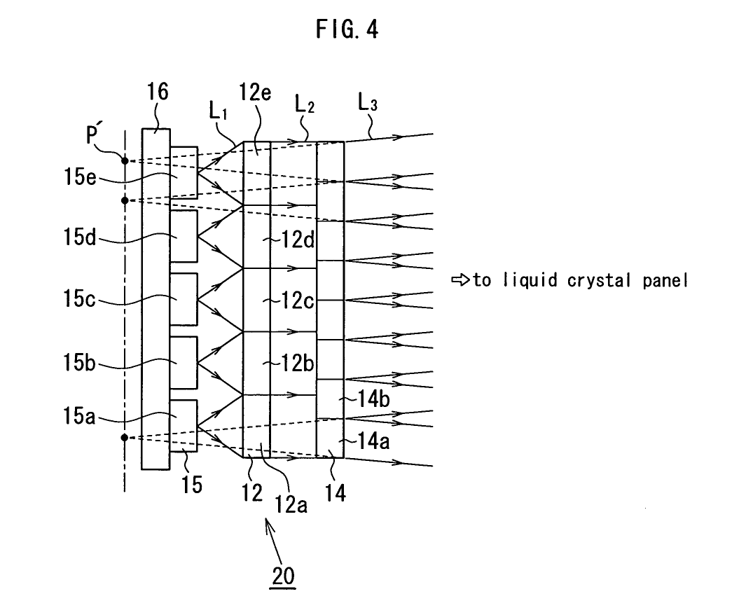

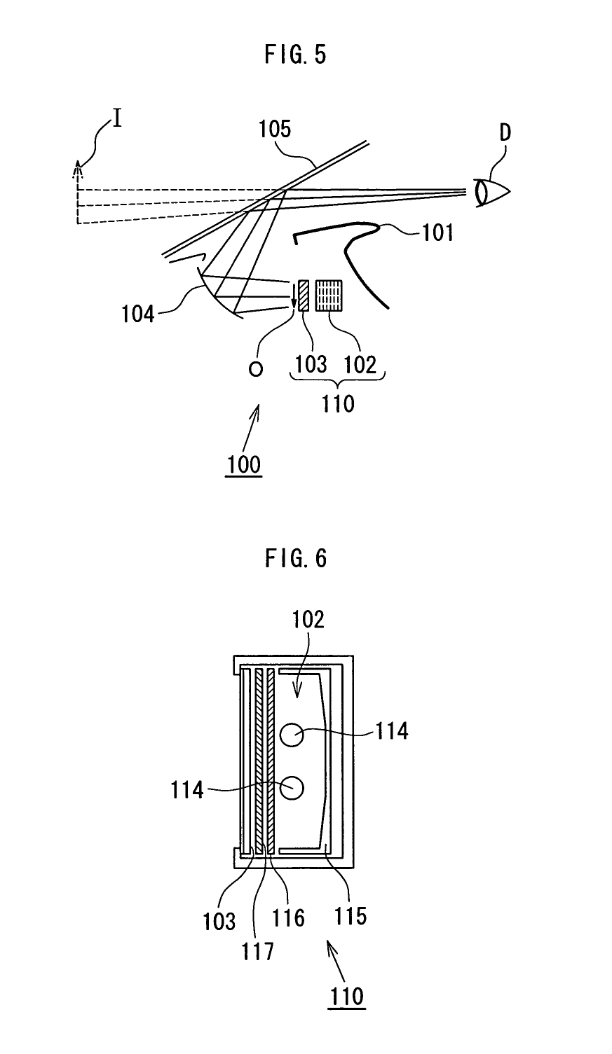

The operation of the illuminating device 20 will be described with reference to FIG. 4. In the present embodiment, the surface light source 15 and the light condensing means 12 are disposed such that the LEDs 15a to 15j are located at respective focal areas of the Fresnel lens cells 12a to 12j, whereby lights L1 emitted from the LEDs 15a to 15j are duly converted into collimated lights L2 by the Fresnel lens cells 12a to 12j so as to enhance the front brightness of the illuminating device 20. The arrangement intervals of the LEDs 15a to 15j and the Fresnel lens cells 12a to 12j, and the diameter of the Fresnel lens cells 12a to 12j can be optimized so that the collimated lights L2 from the light condensing means 12 constitute a light ray of a uniform brightness without boundaries therebetween. Since the Fresnel lens cells 12a to 12j can be designed and produced with the angles of the constituent prisms flexibly determined, their F-value can be set to as small as, for example, about 0.7 in the aforementioned optimization so that the condensing efficiency of the light condensing means 12 can be enhanced as compared with a lens array composed of bulk convex lenses. It is verified by the present inventors that with the surface light source 15 and the light condensing means 12 combined so as to be arranged as described above, the collimated lights L2 from the light condensing means 12 constitute parallel lights which have an excellent directivity defining a half-value width of ±5 degrees on light emission distribution. Thus, the collimated lights L2 coming from the light condensing means 12, already at his stage, provides a high and uniform brightness for the illuminating device 20, and the illuminating device 20 may be essentially constituted without the light diffusing means 14.

Then, the brightness uniformity of the collimated lights L2 achieved as described above is further improved through the light diffusing means 14 disposed at the stage subsequent to the light condensing means 12. The plurality of Fresnel lens cells 14a, 14b and so on of the light diffusing means 14, each functioning as a concave lens, have a smaller diameter than the Fresnel lens cells 12a to 12j of the light condensing means 12 and are arranged in a higher density than the Fresnel lens cells 12a to 12j as described above, and the collimated lights L21 from the light condensing means 12 are subdivided into a plurality of emission lights L3 slightly diverging. Thus, the emission lights L3 from the light diffusing means 14 are composed of lights which are seemingly emitted from secondary light sources (virtual images) P′ present in the same number as the Fresnel lens cells 14a, 14b and so on (thirty two in FIG. 3A), and which overlap one another, and consequently uniformity in brightness is further enhanced.

The light diffusing means 14 composed of an array of Fresnel lenses is adapted to give rise to reduction in light loss compared with, for example, a light diffuser plate used for achieving uniformity in brightness, and is advantageous in that the angles of the prisms constituting each Fresnel lens cell can be flexibly designed and processed thus enabling the density and direction of the emission lights L3 to be controlled. Consequently, in the illuminating device 20, the high directivity achieved by the light condensing means 12 and the high brightness uniformity achieved by the light diffusing means 14 can be optimally balanced for producing the emission lights L3.

In the present embodiment, the Fresnel lens cells 14a, 14b and so on of the light diffusing means 14 are structured to function as a concave lens. However, the present invention is not limited to this structure, and the Fresnel lens cells 14a, 14b and so on may be structured to function as a convex lens, specifically to subdivide and condense the collimated lights L2 from the light condensing means 12 so as to form a number of focal points assumed as secondary light sources, where lights divergingly coming from the secondary light sources overlap one another thus enhancing uniformity in brightness in the same way as the light diffusing means 14 described above. Alternatively, the light diffusing means 14 may be structured to include a combination of Fresnel lens cells functioning as a concave lens and functioning as a convex lens.

Since the illuminating device 20 emits a light with a high directivity and therefore provides a sufficient front brightness with an excellent uniformity in brightness, the light source unit 10 incorporating the illuminating device 20 is suitably used in, for example, an on-vehicle HUD system. This enables reduction in dimension and power consumption on an HUD, and also provides a natural air-cooling system by means of the heat sink 17 thus simplifying a heat dissipating means.

In FIGS. 1A and 1B, the light condensing means 12 and light diffusing means 14 are disposed in a face-to-face manner, but the present invention is not limited to this structure. The light condensing means 12 and the light diffusing means 14 may be disposed in a back-to-back manner, or disposed so as to face toward the same direction, specifically toward either the surface light source 15 or the liquid crystal panel 23. Further, the light condensing means 12 and the light diffusing means 14, which are attached respectively to the transparent plate 11 and the transparent plate 13 in the description of the embodiment shown in FIGS. 1A and 1B, may alternatively be formed integrally at the transparent plates 11 and 13, respectively, or may be formed integrally at respective both surfaces of one transparent plate such that the light condensing means 12 faces the surface light source 15 and the light diffusing means 14 faces the liquid crystal panel 23.

While the present invention has been illustrated and explained with respect to a specific embodiment thereof, it is to be understood that the present invention is by no means limited thereto but encompasses all changes and modifications that will become possible within the scope of the appended claims.

What is claimed is:

1. An illuminating device comprising:
a surface light source comprising a plurality of light emitting diodes disposed two-dimensionally; and
a light condensing means comprising a plurality of Fresnel lenses which are disposed corresponding to respective light emitting diodes, and each of which converts a light from each light emitting diode into a substantially collimated light.

2. An illuminating device according to claim 1, further comprising a light diffusing means disposed at a stage consequent to the light condensing means, the light diffusing means comprising a plurality of Fresnel lenses which have a smaller diameter and are arranged in a higher density than the Fresnel lenses of the light condensing means.

3. An illuminating device according to claim 1, wherein the Fresnel lenses of the light condensing means have an F-value of 1 or smaller.

4. An illuminating device according to claim 2, wherein the Fresnel lenses of the light diffusing means define a concave lens curve in profile.

5. A light source unit comprising:
a liquid crystal panel comprising a pair of substrates functioning as electrodes, and liquid crystals disposed between the pair of substrates; and
an illuminating device disposed behind the liquid crystal panel, the illuminating device structured as described in claim 1.

6. A light source unit comprising:
a liquid crystal penal comprising a pair of substrates functioning as electrodes, and liquid crystals disposed between the pair of substrates; and
an illuminating device disposed behind the liquid crystal panel, the illuminating device structured as described in claim 2.
